(19) United States
(12) Patent Application Publication
(10) Pub. No.: US 2012/0217875 A1
(43) Pub. Date: Aug. 30, 2012

(54) COMPLEX PLASMA GENERATING DEVICE

(76) Inventor: Young Bae Park, Yongin-si (KR)

(21) Appl. No.: 13/505,614

(22) PCT Filed: May 20, 2010
(86) PCT No.: PCT/KR10/03193

§ 371 Date: May 2, 2012

(30) Foreign Application Priority Data
Nov. 2, 2009 (KR) 10-2009-0104933

(51) Int. Cl. H05H 1/28

(52) U.S. Cl. 315/111.21

(57) ABSTRACT

Provided is a complex plasma generating device which makes it possible to enhance an explosion power in such a way that electromagnetic waves are guided to intensively emit to the gas ionized by means of corona discharge by designing a waveguide with electromagnetic waves flowing therein in a spiral curve shape depending on Fibonacci sequence and in such a way that vapor obtained by vaporizing sea water is sprayed.

### BACKGROUND OF THE INVENTION

The present invention relates to a complex plasma generating device which makes it possible to generate a new energy source which can substitute petroleum and coal in such a way to enhance burning performance by applying electromagnetic wave to the gas ionized by corona discharge generating as voltage to two electrodes under a gas spraying environment and at the same time by spraying a hydrogen-oxygen gas.

A corona discharge is a type of discharge under gas environment and is directed to a phenomenon that partial discharge occurs as gas ionizes by applying an AC or DC voltage to two electrodes.

The applicable range of corona discharge is very wide. As one example, the Korean patent registration number 10-0239017 is directed to an application that corona discharge generating by a rapidly oscillating electric field is adapted to an indoor air treatment or the Korean paten registration number 10-0194975 is directed to an exhaust gas purification device using a corona discharge device generating gas in the form of plasma by means of corona discharged by voltage.

As mentioned in the above, the corona discharge is generally adapted to degrade or treat the harmful substances contained in the air or is generally adapted to modify the surface of metal or synthetic resin.

The electromagnetic wave or microwave represents an electromagnetic radiation the wavelength of which is 1 mm and 10 cm and generates by klystron and magnetron in terms of electromagnetic wave having a wavelength between radio wave and infrared ray. In terms of its application, it is generally used to heat or dehydrate a certain object like a microwave oven or it might be used as an ignition device such as a torch or the something.

Since the capacity of an ignition device by means of pure electromagnetic waves is determined depending on the dimension of an electromagnetic wave generating device, a huge size electromagnetic wave generating device is needed for the application to a huge system which melts wastes, so economic efficiency is not good.

In the industry, it is urgently to develop a small size and inexpensive plasma generating device which is able to generate a flame with a high temperature and a good burning performance.

### SUMMARY OF THE INVENTION

Accordingly, it is an object of the present invention to provide a complex plasma generating device which can substitute petroleum and coal in such a way to enhance burning performance with a simple structure by applying electromagnetic wave to the gas ionized by corona discharge generating as voltage to two electrodes under a gas spraying environment and at the same time by spraying a hydrogen-oxygen gas.

It is another object of the present invention to provide a complex plasma generating device which makes it possible to enhance an explosion power in such a way that electromagnetic waves are guided to intensively emit to the gas ionized by means of corona discharge by designing a waveguide with electromagnetic waves flowing therein in a spiral curve shape depending on Fibonacci sequence and in such a way that vapor obtained by vaporizing sea water is sprayed.

To achieve the above objects, there is provided a complex plasma generating device, comprising a corona discharge part (10) characterized in that air is injected into the interior of a housing (11) with a certain length, and a first electrode (14) and a second electrode (16) are spaced apart at the center and an inner wall of the housing and the corona discharge part comprises a crystal tube (15) between the electrodes; an electromagnetic wave generating part (20) characterized in that a shaft hole 23 is formed at one side of a waveguide (22) in which electromagnetic waves flow, and an end portion of the housing (11) is vertically engaged to the shaft hole (23), and a crystal tube (15) that an electromagnetic wave reaches and that passes through the electromagnetic wave generating part; a combustion gas generator (30) producing combustion gas; an ignition plug 18 which is installed at an inner side of a flame spraying port (19) communicating with the shaft hole (23); and a gas spray 50 which sprays gas to around the ignition plug.

In a preferred embodiment of the present invention, the shaft hole (23) is formed at a portion eccentric from the waveguide (22) having a certain length, and the waveguide (22) is formed in a spiral curve shape in the direction of the shaft hole (23), and the spiral curve is a curve depending on the Fibonacci sequence.

### BRIEF DESCRIPTION OF DRAWINGS

The present invention will become better understood with reference to the accompanying drawings which are given only by way of illustration and thus are not limitative of the present invention, wherein;

FIG. 1 is a disassembled perspective view illustrating key elements of a complex plasma generating device according to the present invention;

FIG. 2 is an assembled perspective view illustrating a complex plasma generating device according to the present invention;

FIG. 3 is a cross sectional view illustrating an operation state of a complex plasma generating device according to a first embodiment of the present invention;

FIG. 4 is a plane view illustrating a corona discharge part according to the present invention;

FIG. 5 is a plane view illustrating the type of a waveguide of an electromagnetic wave generation part according to the present invention;

FIG. 6 is a cross sectional view illustrating an operation state of a complex plasma generating device according to a second embodiment of the present invention; and

FIG. 7 is a photo of a state that a flame generates from a complex plasma generation device according to the present invention.

### BRIEF DESCRIPTIONS OF KEY ELEMENTS OF THE DRAWINGS

| 4: shield ring | 5: metallic plate |
|---|---|
| 10: corona discharge part | 11: housing |
| 11′, 19′, 22′: flange | |
| 12: air sprayer | 13: electrode rod |
| 14: first electrode | 15: crystal tube |
| 16: second electrode | 17: insulator |
| 18: ignition plug | 19: flame spray port |
| 20: electromagnetic wave generation part | |
| 21: electromagnetic wave generator | |
| 22: waveguide | 23: shaft hole |
| 24: curve | |
| 30: combustion gas generator | |
| 31: first pipe | 32: exhaust hole |
| 35: electrode | 36: coil |
| 40: seawater tank | 41: second pipe |
| 50: gas sprayer | |
| W: water | M: electromagnetic wave |
| S: seawater | |

### DETAILED DESCRIPTION OF THE INVENTION

The preferred embodiments of the present invention will be described with reference to the accompanying drawings. The structures shown in the drawings are just provided for the purpose of showing a preferred example of the present invention, not to limit the present invention.

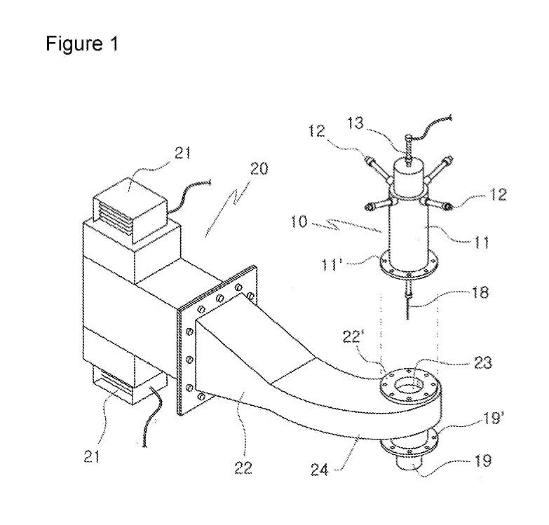

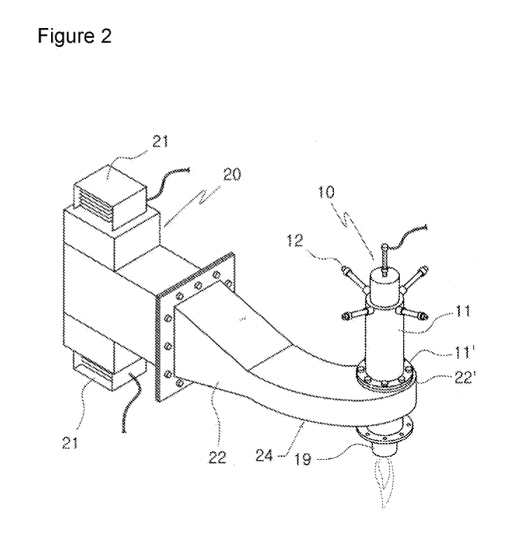

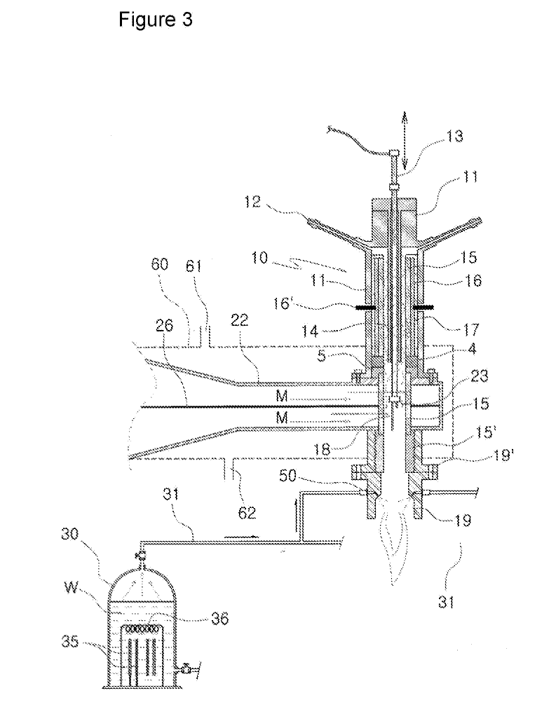

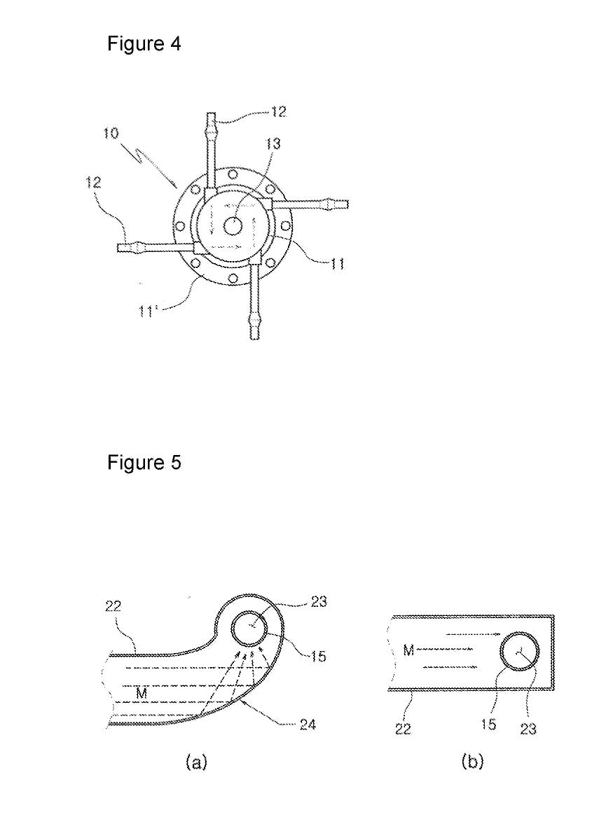

FIG. 1 is a disassembled perspective view illustrating key elements of a complex plasma generating device according to the present invention. FIG. 2 is an assembled perspective view illustrating a complex plasma generating device according to the present invention. FIG. 3 is a cross sectional view illustrating an operation state of a complex plasma generating device according to a first embodiment of the present invention. FIG. 4 is a plane view illustrating a corona discharge part according to the present invention. FIG. 5 is a plane view illustrating the type of a waveguide of an electromagnetic wave generation part according to the present invention.

As shown in FIGS. 1 to 3, the complex plasma generation device according to a first embodiment of the present invention comprises a unit consisting of a corona discharge part 10 and an electromagnetic wave generating part 20 and another unit consisting of a combustion gas generating part 30 and a gas sprayer 50. The waveguide 22 of the electromagnetic wave generating part 20 is formed in a straight line or a curved line as shown in FIG. 5, the detailed construction of which will be described later.

The corona discharge part 10 comprises a housing 11 with a certain length. At least one air sprayer 12 is installed in the interior of the housing 11 at one side (upper side) of the housing for the purpose of air injection, and a flange 11′ is installed at the other side (lower side) of the same and is engaged with a flange 22′ positioned at the upper side of the shaft hole 23 of the electromagnetic wave generation part 20 by means of a fixing member such as a bolt or something.

As shown in FIG. 3, the air sprayer 12 is downwardly slanted toward the center of the housing 11, and as shown in FIG. 4, since it is eccentrically installed from the center when viewing it from the plane, the air injected via the air sprayer 12 whirls in the housing 11 and flows downward.

The electrode rod 13 passes through the inner side of the housing at the center of the upper side of the housing 11, and the first electrode 14 is disposed at the center of the interior of the housing 11, and the electrode rod 13 and the first electrode 14 are electrically connected.

At an inner side of the housing 11 is formed a second electrode 16 which is spaced apart from the first electrode 14. The second electrode 14 is electrically conducted via the electrode 16′ passing through the side of the housing 11. At an inner surface of the second electrode 16 of the inner wall of the housing is installed the crystal tube 15. Between the second electrode 16 and the inner wall of the housing 11 is disposed the insulator 17, thus insulating the second electrode 16 and the housing 11.

At one side of the electromagnetic wave generation part 20 is installed an electromagnetic wave generator 21 generating electromagnetic waves M, and at the other side of the same is positioned a shaft hole 23 engaged to the housing 11. At least one or two electromagnetic wave generators 21 are provided or a plurality of the same are provided. In case that a plurality of the same are provided, a partition 26 separating the waveguide 22 into upper and lower parts is provided so that the electromagnetic waves generating from each electromagnetic wave generator 21 can be separate from each other until they reach the lower crystal tube 15 of the interior of the shat hole 23 via the waveguide 22. In this case, since the electromagnetic wave generator 21 of a small capacity is provided in multiple numbers, so it is preferred in terms of cost saving and compact construction.

The waveguide 22 is a passage helping move the electromagnetic waves M generating from the electromagnetic wave generator 21 move toward the shaft hole 23, and at a periphery of the shaft hole 23 is installed a lower crystal tube 15 separated from the upper crystal tube 15 installed at the inner surface of the housing 11. The crystal tube 15 is separated from the lower crystal tube 15 installed at the upper crystal tube 15 installed in the interior of the housing 11 and the shaft hole 23 of the waveguide 22. Between the crystal tubes is installed a shield ring 4 and a metallic ring 5, respectively.

The shield ring 4 is made from an insulated material such as a ceramic or something and separates the upper crystal tube and the lower crystal tube and insulates the same, and the metallic ring 5 is a magnetron electrode electrically conducting the housing 11 and the lower crystal tube 15.

As shown in FIG. 5B, the waveguide 22 might be formed in a plane straight shape which is generally adapted, and preferably as shown in FIG. 5A, it might be formed in a plane spiral curve shape. In case that the waveguide 22 is formed in a spiral curve shape, the curve is preferably shaped depending on Fibonacci sequence like the shape of cochlea or the shape that the seeds of sunflower are arranged.

In this case, as shown in FIG. 5A, when the electromagnetic waves M are reflected as they collide with the surface of the curve 24 depending on Fibonacci sequence, it can be seen that they are reflected toward the lower crystal tube 15 of the shaft hole 23 where ever they are positioned. Since the lower crystal tube 15 and the waveguide 2 surrounding the same are formed in circles, the electromagnetic waves M do not lose by means of the cavity oscillation in the circular shape, namely, they are focused on the crystal tube 15, thus increasing efficiency.

As shown in FIG. 3, an inlet port 61 is formed at one side for cooling water to circulate near the waveguide 22. A cooling water casing 60 with an outlet port 62 is installed at the other side, thus cooling the heat generating due to the electromagnetic waves as the cooling water circulates.

At a lower side of the lower crystal tube 15 is provided a crystal tube fixing tube 15′, and at an outer surface of the fixing tube 15′ is installed a flame spray port 19, and the fixing tube 15′ and the flame spray port 19 are engaged via a screw, and at an outer surface of the flame spray port 19 is formed a flange 19′ for an engagement to a proper portion of a melting furnace of a heating furnace.

An ignition plug 18 installed at a lower side of the electrode rd 13 is provided for the purpose of flame ignition.

The ignition plug 18 is extended from the electrode rod 13 for thereby applying current from the electrode rod 13. The electrode rod 13 passes through the interior of the first electrode 14 and is positioned in the interior of the lower crystal tube, and the electrode rod 13 is installed to reciprocate upward and downward by means of a mechanical driving means such as a cylinder hydraulic device or a motor.

The combustion gas generator 30 is a device producing combustion gas to be sprayed to the surrounding of the ignition plug 18. As shown in the drawing, it might be driven based on the water electrolysis method in such a way that at least one pair of the electrodes 3 are installed at a lower side of the container with water W stored therein, and a coil 36 is disposed near the electrode 35. The present invention is not limited thereto.

The combustion gas might be hydrogen-oxygen gas or parahydrogen. The parahydrogen, which is one of the combustion gas, burns slow unlike orthohydrogen with a good combustion performance. So it is proper to be used as a flame source of cooking device line a gas stove. The combustion gas of the present invention is not limited thereto, and a certain combustion gas might be used as long as it burns. The kinds of the same are not limited thereto.

When the combustion gas generator 30 is adapted to produce hydrogen-oxygen gas, water electrolysis method might be adapted. In this case, since only water is used to produce such gas without adding a chemical catalyst, it is advantageous in terms of manufacture and environment.

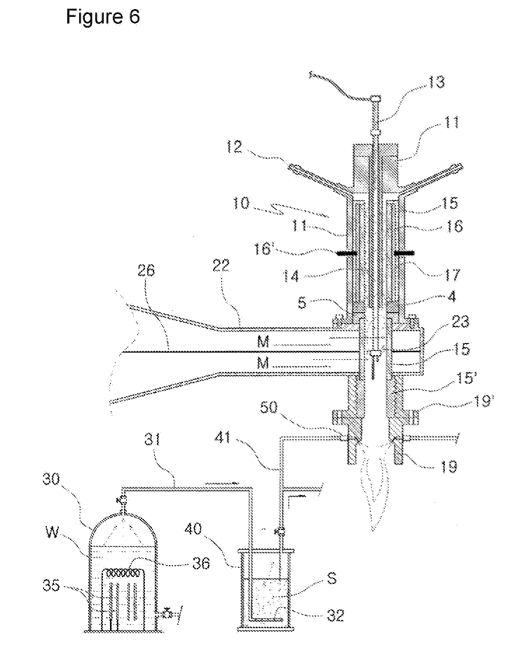

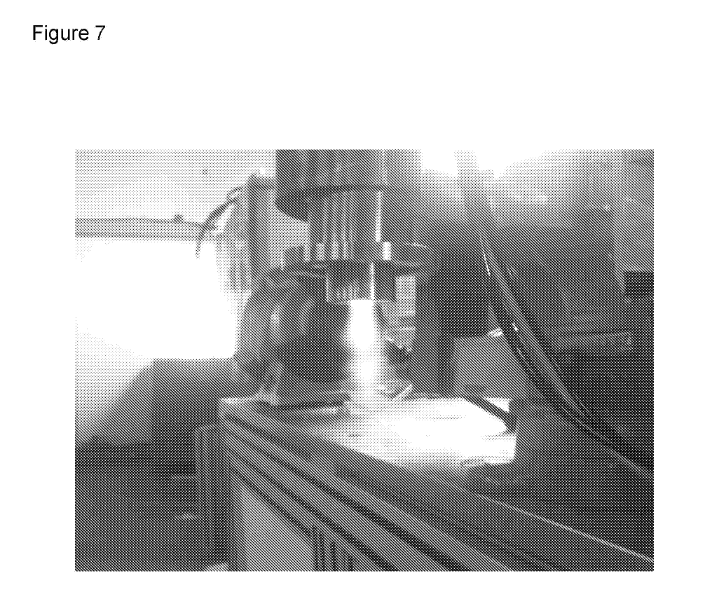

FIG. 6 is a cross sectional view illustrating an operation state of a complex plasma generating device according to a second embodiment of the present invention. FIG. 7 is a photo of a state that a flame generates from a complex plasma generation device according to the present invention.

When the corona discharge part 10 and the electromagnetic wave generating part 20 and the combustion gas generator 30 have the same conditions, burning performance and temperature can rise by inputting seawater gas which is obtained by vaporizing sea water, toward around the ignition plug 18. Since sea water contains a lot of heavy hydrogen or salt, they help increase explosion power when such components involve in building flame, so the flame from the flame spray port 19 is hot, and the temperature rises.

A certain device converting seawater into gas might be provided, so the gas can be sprayed to around the ignition plug 18 via a certain passage separately from the combustion gas. As shown in FIG. 6, it is preferred that the gas can be sprayed via the gas sprayer 50 by combining with the combustion gas.

As shown in FIG. 6, at least one exhaust hole 32 is formed at an end portion of the first pipe 31 in order for the combustion as to be saturated in the seawater tank 40 as an end portion of the first pipe 31 connected with the combustion gas generator 30 is immersed in the lower side of the seawater tank 40. The second exhaust pipe 41 retrieving the combustion gas saturated and rising from the upper side of the seawater tank 40 is connected with the gas sprayer 50.

The combustion gas is moved to the bottom of the seawater tank 40 via the first pipe 31 and is discharged into the interior of the seawater via the exhaust hole 32. The gas rising and floating in small foams in the seawater is coupled with heavy hydrogen and/or salt contained in the seawater. The combustion gas contained in the seawater gas is retrieved into the second pipe 41 and is sprayed via the gas sprayer 50, so the intensity of flame and temperature can rise.

The operation of the present invention will be described with reference to FIG. 3 or 6, and the present invention might be embodied in details therewith.

First of all, when the air is inputted into the housing via the air sprayer 12 and moves downwards in a vortex shape, the first electrode 14 and the second electrode 14 are electrically conducted, and corona discharge occurs, so the vortex air is ionized.

When the ionized air passes through the shaft hole 23, the ionized air is accelerated as it is exposed to the electromagnetic waves M guided by the waveguide 22. As the ignition plug 18 reciprocates upward and downward in the interior of the lower crystal tube 15, sparks occur at the ignition plug 18 due to a high electric charge applied thereto, thus generating flame.

At this time, since the combustion gas, for example, hydrogen-oxygen gas or parahydrogen gas is sprayed into in the flame pray port, gas and air burn together, so strong flame is generated below the flame spray port 19.

The flame rising via the flame spray port 19 as shown in the photo of FIG. 7 explodes by means of the air the ionization of which is accelerated unlike the flame of common plasma, the flame is a big size and have a high temperature, so the present invention can be installed at a melting furnace which melts wastes for recycling or a heating furnace, whereby it is possible to substitute fossil energy such as coal or petroleum.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

In the present invention, it is possible to generate a strong flame with a simple structure in such a way that electromagnetic waves are applied to a gas ionized by corona discharge and at the same time hydrogen-oxygen gas is sprayed. When adapted to a heating furnace or a melting furnace it is possible to obtain a high efficiency with a low cost.

In addition, the waveguide is designed in a spiral curve depending on the Fibonacci sequence, so the electromagnetic waves are focused on the gas ionized by discharge, and the explosion force can be enhanced by spraying vapor which is generated by vaporizing seawater. In this case, the present invention is advantageous to be adapted to a big size heating furnace or a melting furnace.

In addition, since it is not needed for flame to combust fossil fuel such as petroleum or coal according to the plasma generating device of the present invention, it is possible to save energy resource which is depleting in recent years, and since harmful gas such as carbon dioxide which used to generate during combustion dos not generate, thus preventing environment contamination.

1. A complex plasma generating device, comprising:
a corona discharge part (10) characterized in that air is injected into the interior of a housing (11) with a certain length, and a first electrode (14) and a second electrode (16) are spaced apart at the center and an inner wall of the housing and the corona discharge part comprises a crystal tube (15) between the electrodes;
an electromagnetic wave generating part (20) characterized in that a shaft hole 23 is formed at one side of a waveguide (22) in which electromagnetic waves flow, and an end portion of the housing (11) is vertically engaged to the shaft hole (23), and a crystal tube (15) that an electromagnetic wave reaches and that passes through the electromagnetic wave generating part;
a combustion gas generator (30) producing combustion gas;
an ignition plug (18) which is installed at an inner side of a flame spraying port (19) communicating with the shaft hole (23); and
a gas spray (50) which sprays gas to around the ignition plug.

2. The device of claim 1, wherein said shaft hole (23) is formed at a portion eccentric from the waveguide (22) having a certain length, and said waveguide (22) is formed in a spiral curve shape in the direction of the shaft hole (23).

3. The device of claim 2, wherein said spiral curve is a curve depending on the Fibonacci sequence.

4. The device of claim 1, wherein said waveguide (22) around the shaft hole (23) is formed in a cylindrical shape for the oscillation of the electromagnetic waves M.

5. The device of claim 1, wherein an electromagnetic wave generator (21) is installed at an upper and lower side of one side of the waveguide (22), and a partition (26) separating and guiding the electromagnetic waves M generated from each electromagnetic wave generator is disposed in the interior of the waveguide.

6. The device of claim 1, wherein a cooling water casing (60) with an inlet port (61) and an outlet port (62) is installed outside the waveguide (22) in order for the cooling water to circulate.

7. The device of claim 1, wherein said ignition plug (18) is extended until the flame spray port (19) via the first electrode (14) of the center of the housing (10).

8. The device of claim 1, wherein said combustion gas generator (30) is implemented based on a water electrolysis method characterized in that a pair of electrodes (35) are installed close to each other at a lower side of the container with water stored therein, and a coil (36) is formed around the electrodes.

9. The device of claim 1, wherein an insulator (17) is disposed between the inner wall of the housing (11) and the second electrode (16).

10. The device of claim 1, wherein seawater gas obtained by vaporizing seawater except for combustion gas is sprayed to around the ignition plug.

11. The device of claim 10, wherein at least one exhaust hole (32) is formed at an end portion of the first pipe (31) so that the seawater gas is combined with the combustion gas and is sprayed via the gas sprayer (50), and the combustion gas can be saturated in the seawater tank since an end portion of the first pipe (31) connected with the combustion gas generator (30) is immersed in the lower side of the seawater tank (40), and the second pipe (41) retrieving the combustion gas saturated and rising from the upper side of the seawater tank (40) is connected with the gas sprayer (50).

12. The device of claim, wherein an air sprayer (12) injecting air into the interior of the housing (11) is slanted in a downward direction toward the center of the housing and is connected with the center in an eccentric shape, so the air injected moves downward in a vortex shape.

13. The device of claim 2, wherein an electromagnetic wave generator (21) is installed at an upper and lower side of one side of the waveguide (22), and a partition (26) separating and guiding the electromagnetic waves M generated from each electromagnetic wave generator is disposed in the interior of the waveguide.

14. The device of claim 3, wherein an electromagnetic wave generator (21) is installed at an upper and lower side of one side of the waveguide (22), and a partition (26) separating and guiding the electromagnetic waves M generated from each electromagnetic wave generator is disposed in the interior of the waveguide.

15. The device of claim 4, wherein an electromagnetic wave generator (21) is installed at an upper and lower side of one side of the waveguide (22), and a partition (26) separating and guiding the electromagnetic waves M generated from each electromagnetic wave generator is disposed in the interior of the waveguide.

16. The device of claim 2, wherein a cooling water casing (60) with an inlet port (61) and an outlet port (62) is installed outside the waveguide (22) in order for the cooling water to circulate.

17. The device of claim 3, wherein a cooling water casing (60) with an inlet port (61) and an outlet port (62) is installed outside the waveguide (22) in order for the cooling water to circulate.

18. The device of claim 4, wherein a cooling water casing (60) with an inlet port (61) and an outlet port (62) is installed outside the waveguide (22) in order for the cooling water to circulate.
